(19) United States
(12) Patent Application Publication
(10) Pub. No.: US 2024/0250265 A1
(43) Pub. Date: Jul. 25, 2024

(54) ELECTRODE FOR NON-AQUEOUS ELECTROLYTE RECHARGEABLE BATTERY AND NON-AQUEOUS ELECTROLYTE RECHARGEABLE BATTERY

(71) Applicant: SAMSUNG SDI CO., LTD., Yongin-si (KR)

(72) Inventors: Yuta TASHIRO, Yokohama-shi (JP); Hidekazu YAMAMOTO, Yokohama-shi (JP)

(21) Appl. No.: 18/421,336

(22) Filed: Jan. 24, 2024

(30) Foreign Application Priority Data
Jan. 24, 2023 (JP) 2023-008963
Jan. 23, 2024 (KR) 10-2024-0010458

(51) Int. Cl. H01M 4/62; H01M 4/02; H01M 4/131

(52) U.S. Cl. CPC H01M 4/622; H01M 4/131; H01M 4/625; H01M 2004/021

(57) ABSTRACT

An electrode for a non-aqueous electrolyte rechargeable battery and includes a current collector, an electrode mixture layer, and a base layer between the current collector and the electrode mixture layer. The base layer includes a styrene-acrylic acid ester-based copolymer, a carbon material, and/or a poly(meth)acrylic acid, and a content of the styrene-acrylic acid ester-based copolymer in the base layer may be greater than or equal to about 70 mass % and less than or equal to about 90 mass %. The poly(meth)acrylic acid has carboxyl groups that may not be neutralized, or a proportion of the carboxyl groups may be neutralized by alkali metal ions to be at most 25%. A weight per unit area of the electrode mixture layer per one surface of the current collector may be between about 10 mg/cm² and about 35 mg/cm².

### CROSS-REFERENCE TO RELATED APPLICATION

This application claims priority to and the benefit of Japanese Patent Application No. 2023-008963 filed in the Japan Patent Office on Jan. 24, 2023, and Korean Patent Application No. 10-2024-0010458 filed in the Korean Patent Office on Jan. 23, 2024, the entire content of each of which is incorporated herein by reference.

### BACKGROUND

### 1. Field of the Invention

According to one or more embodiments, the present disclosure relates to an electrode for a non-aqueous electrolyte rechargeable battery and a non-aqueous electrolyte rechargeable battery including the electrode.

### 2. Description of the Related Art

Non-aqueous electrolyte rechargeable batteries, including lithium ion rechargeable batteries, are widely utilized as power sources for smart phones, notebook computers, and/or the like. More recently, as these electronic devices have become smaller and lighter, there is an increasing need (or a desire) for rechargeable batteries to have higher energy densities.

In addition, in recent years, the demand (or the desire) for rechargeable batteries to be utilized as a power source for electric vehicles, hybrid vehicles, and/or the like has been increasing, and there is a demand (or a desire) for rechargeable batteries having relatively high energy density to ensure the same performance as comparable gasoline engines.

One example of a method for increasing an energy density of a rechargeable lithium ion battery is to increase a weight per unit area of the electrode mixture layer.

Normally, in the production of an electrode mixture layer, it is common to obtain the electrode mixture layer by coating and drying an electrode mixture slurry onto a thin current collector. However, as the weight per unit area of the electrode mixture layer is increased, a binder is more likely to migrate to the surface of the current collector, and the electrode mixture layer may or is likely to fall off or peel off (e.g., away) from the current collector.

Accordingly, in the production of an electrode mixture layer with a large weight per unit area, a method of dry mixing and kneading an electrode mixture composition, forming it into a sheet utilizing a calendar press, and/or the like, and then bonding it to a current collector is also utilized. Here, as a method of preventing or reducing the electrode mixture layer from falling off or peeling off from the current collector, it is being considered to provide a base layer (e.g., a conductive base layer) between the current collector and the electrode mixture layer, as shown in Japanese Patent Publication No. 2020/196372 (Patent Document 1). The entire content of Patent Document 1 is incorporated herein by reference.

### SUMMARY

According to the present inventors' insight and examination, the base layer of a rechargeable battery does not include an electrode active material and does not contribute to increasing the energy density of the rechargeable battery. Therefore, in order to increase energy density (e.g., realize high energy density), it is required (or there is desire) to make a thickness of the base layer thinner.

For example, the present inventor, who further investigated the peeling off (e.g., away) of the electrode mixture layer from a current collector foil, noted that in actual battery configuration, the electrode is immersed in an electrolyte solution and the electrode is utilized in a state in which the electrolyte solution is impregnated. After the electrode is immersed, it has been found that the electrode mixture layer may become easier to peel off (e.g., away) from the current collector than in the state before immersion in the electrolyte solution, especially in the case of the negative electrode mixture layer. On the other hand, there is no study at all about the falling off or peeling off (e.g., away) from the electrode mixture layer after immersion in the electrolyte solution.

The present disclosure has been made in view of the herein-mentioned problems, and while making a thickness of the base layer as small as possible, a negative electrode for a non-aqueous electrolyte rechargeable battery has a base layer (e.g., a conductive base layer) that may sufficiently prevent or protect the electrode mixture layer from falling off or peeling off (e.g., away) from the current collector. For example, the electrode mixture layer may be prevented or protected from falling off or peeling off (e.g., away) from the current collector even after immersion in an electrolyte solution (e.g., in which the electrode mixture layer tends to fall off or peel off (e.g., away)).

One or more aspects or embodiments of the present disclosure are as follows.

One or more aspects or embodiments are directed toward an electrode including a current collector, an electrode mixture layer, and a base layer (e.g., a conductive base layer) between the current collector and the electrode mixture layer,
wherein the electrode may be for a non-aqueous electrolyte rechargeable battery,
the base layer includes at least one selected from among a styrene-acrylic acid ester-based copolymer, a carbon material, and a poly(meth)acrylic acid,
a content (e.g., an amount) of the styrene-acrylic acid ester-based copolymer in the base layer may be greater than or equal to about 70 mass % and less than or equal to about 90 mass %,
the poly(meth)acrylic acid includes a plurality of carboxyl groups that are not neutralized, or a proportion of neutralized carboxyl groups neutralized by alkali metal ions among the carboxyl groups may be less than or equal to about 25%, and
a weight per unit area of the electrode mixture layer per one surface of the current collector may be greater than or equal to about 10 mg/cm² and less than or equal to about 35 mg/cm².

In some embodiments, a content (e.g., an amount) of the styrene-acrylic acid ester-based copolymer in the base layer may be greater than about 77.5 mass % and less than or equal to about 90 mass %.

In some embodiments, a content (e.g., an amount) of the styrene-acrylic acid ester-based copolymer in the base layer may be greater than or equal to about 78 mass % and less than or equal to about 90 mass %.

In some embodiments, a content (e.g., an amount) of the styrene-acrylic acid ester-based copolymer in the base layer may be greater than or equal to about 78 mass % and less than or equal to about 88 mass %.

In some embodiments, the base layer has a thickness of greater than or equal to about 0.5 micrometer (μm) and less than or equal to about 5 μm.

In some embodiments, the base layer has a thickness of greater than or equal to about 0.5 μm and less than or equal to about 2 μm.

In some embodiments, the styrene-acrylic acid ester-based copolymer has a glass transition temperature of greater than or equal to about −20° C. and less than or equal to about 20° C.

In some embodiments, the electrode mixture layer includes greater than or equal to about 0.5 mass % and less than or equal to about 10 mass % of polytetrafluoroethylene.

In some embodiments, the plurality of carboxyl groups in the poly(meth)acrylic acid may be not neutralized, or a proportion of neutralized carboxyl groups may be greater than about 0% and less than or equal to about 10%.

In some embodiments, the carbon material includes at least one selected from among furnace black, channel black, thermal black, ketjen black, and acetylene black.

One or more aspects or embodiments are directed toward a non-aqueous electrolyte rechargeable battery including a positive electrode, a negative electrode, a separator, and an electrolyte, wherein at least one of the positive electrode and the negative electrode may be the electrode as described herein.

According to the present disclosure, a negative electrode for a non-aqueous electrolyte rechargeable battery has a base layer capable of sufficiently suppressing or preventing the falling-off or peeling off (e.g., away) of an electrode mixture layer even after immersion in an electrolyte solution (e.g., in which falling-off or peeling off (e.g., away) of the electrode mixture layer is likely to occur), while keeping the thickness of the base layer suitably thin (e.g., as small as possible). Additional aspects will be set forth in part in the description which follows and, in part, will be apparent from the description, or may be learned by practice of the presented embodiments of the disclosure.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. As utilized herein, the term “and/or” includes any and all combinations of one or more of the associated listed items. Expressions such as “at least one of,” if (e.g., when) preceding a list of elements, modify the entire list of elements and do not modify the individual elements of the list.

As the present disclosure described hereinafter allows for one or more suitable changes and numerous embodiments, embodiments will be illustrated in the drawings and described in more detail in the detailed description.

Hereinafter, embodiments will be described in more detail so that those of ordinary skill in the art can easily implement them. However, this disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise. Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

As utilized herein, the phrase “combination thereof” refers to a mixture, laminate, composite, copolymer, alloy, blend, reaction product, and/or the like of the constituents.

As used herein, singular forms such as “a,” “an,” and “the” are intended to include the plural forms as well, unless the context clearly indicates otherwise.

As used herein, the terms “use,” “utilizing,” and “used” may be considered synonymous with the terms “utilize,” “utilizing,” and “utilized,” respectively.

As used herein, expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Herein, it should be understood that terms such as “comprises,” “comprise,” “comprising,” “includes,” “including,” “include,” “having,” “has,” or “have” are intended to designate the presence of an embodied feature, number, step, element, or a combination thereof, but it does not preclude the possibility of the presence or addition of one or more other features, number, step, element, or a combination thereof.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

In present disclosure, “not include (or not including) a or any ‘component’”, “exclude (or excluding) a or any ‘component”, “component’-free”, and/or the like refers to that the “component” not being added, selected or utilized as a component or compound in the composition, but the “component” of less than a suitable amount may still be included due to other impurities and/or external factors.

It will be understood that if (e.g., when) an element such as a layer, film, region, or substrate is referred to as being “on” another element, it can be directly on the other element or intervening elements may also be present. In contrast, if (e.g., when) an element is referred to as being “directly on” another element, there are no intervening elements present.

### Definitions

The term “layer,” as utilized herein includes not only a shape formed on the whole surface if (e.g., when) viewed from a plan view, but also a shape formed on a partial surface.

The term “particle diameter,” as utilized herein, may be an average particle diameter that may be measured by a method well suitable to those skilled in the art, and, for example, may be measured by a particle size analyzer (PSA), or may be measured by a transmission electron microscopic (TEM) image or a scanning electron microscopic (SEM) image.

In some embodiments, it may be possible to obtain an average particle diameter value by measuring utilizing a dynamic light scattering method, performing data analysis, counting the number of particles for each particle size range, and calculating from this. Unless otherwise defined, the average particle diameter may refer to the diameter (D₅₀) of particles having a cumulative volume of 50 volume % in the particle size distribution. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or length of the long axis) of about 20 particles at random in a scanning electron microscope image. Also, depending on context, when particles are spherical, “diameter” indicates a particle diameter or an average particle diameter, and when the particles are non-spherical, the “diameter” indicates a major axis length or an average major axis length.

The term “or,” as utilized herein is not to be construed as an exclusive meaning, for example, “A or B” is construed to include A, B, A+B, and the like.

The term “metal,” as utilized herein is interpreted as a concept including ordinary metals, transition metals and metalloids (semi-metals).

Hereinafter, a configuration of a non-aqueous electrolyte rechargeable battery according to some embodiments will be described.

### 1. Basic Configuration of Non-Aqueous Electrolyte Rechargeable Battery

The non-aqueous electrolyte rechargeable battery according to some embodiments may be a rechargeable lithium ion battery including a positive electrode, a negative electrode, a separator, and a non-aqueous electrolyte configured to be accommodated (e.g., by them) therebetween or therein.

The shape of the rechargeable lithium ion battery is not particularly limited, but may be, for example, a cylindrical shape, a prismatic shape, a laminated shape, or a button shape.

### 1-1. Positive Electrode

The positive electrode may include a positive electrode current collector and a positive electrode mixture layer on the positive electrode current collector.

The positive electrode current collector may be any material as long as it is a conductor, and may be, for example, plate-shaped or thin, and may be suitably or desirably made of aluminum, stainless steel, nickel coated steel, or the like.

The positive electrode mixture layer may include at least a positive electrode active material, and may further include a conductive agent and a positive electrode binder.

The positive electrode active material may be, for example, a transition metal oxide or a solid solution oxide including lithium. The positive electrode active material is not particularly limited as long as it may electrochemically intercalate and deintercalate lithium ions. Examples of the transition metal oxide including lithium may include Li_{1.0}Ni_{0.88}Co_{0.1}Al_{0.01}Mg_{0.01}O₂, and/or the like. For example, Li—Co composite oxides such as LiCoO₂ and Li—Ni—Co—Mn-based composite oxides such as LiNiₓCo_{y}Mn_{z}O₂, Li—Ni-based composite oxide such as LiNiO₂, or Li—Mn-based composite oxides such as LiMn₂O₄, and/or the like. Examples of the solid solution oxide may include LiₐMnₓCo_{y}Ni_{z}O₂ (1.150≤a≤1.430, 0.45≤x≤0.6, 0.10≤y≤0.15, 0.20≤z≤0.28), LiMn_{1.5}Ni_{0.5}O₄. On the other hand, a content (e.g., an amount) (content ratio) of the positive electrode active material is not particularly limited, as long as it is applicable to the positive electrode mixture layer of a non-aqueous electrolyte rechargeable battery. Moreover, these compounds may be utilized alone or may be utilized in mixture of plural types (or kinds).

The conductive agent is not particularly limited as long as it is for increasing the conductivity of the positive electrode. Some examples of the conductive agent may include those including at least one selected from among carbon black, natural graphite, artificial graphite, fibrous carbon, and sheet-like carbon. Examples of the carbon black may include at least one selected from among furnace black, channel black, thermal black, ketjen black, and acetylene black. Examples of the fibrous carbon may include carbon fiber and/or the like. Examples of the fibrous carbon may include carbon nanotubes and carbon nanofibers, and examples of the sheet-like carbon may include graphene and/or the like. The content (e.g., an amount) of the conductive agent is not particularly limited, and may be any content (e.g., an amount) applicable to the positive electrode mixture layer of a non-aqueous electrolyte rechargeable battery.

The positive electrode binder may be any material capable of binding the positive electrode active material and the conductive agent onto the positive electrode current collector, and is not particularly limited. The positive electrode binder may include, for example, a polyvinylidene fluoride (PVDF), polytetrafluoroethylene (PTFE), poly(meth)acrylic acid (polyacrylic acid (PAA) or polymethacrylic acid (PMA)), a styrene butadiene-based copolymer (SBR), a carboxylmethyl cellulose metal salt (CMC), and/or the like

One type (or kind) of binder may be utilized individually, or two or more types (or kinds) may be included (e.g., contained).

### 1-2. Negative Electrode

The negative electrode may include a negative current electrode collector and a negative electrode mixture layer on the negative electrode current collector.

The negative current collector may be anything as long as it is a conductor, and may be desirably plate-shaped or thin, and made of copper, stainless steel, nickel-plated steel, and/or the like.

The negative electrode mixture layer may include a negative electrode active material, and may further include a conductive agent and a negative electrode binder.

The negative electrode active material is not particularly limited as long as it may electrochemically intercalate and deintercalate lithium ions. The negative electrode active material may be, for example, a graphite active material (artificial graphite, natural graphite, a mixture of artificial graphite and natural graphite, natural graphite coated with artificial graphite), a Si-based active material, or a Sn-based active material (e.g., a mixture of fine particles of silicon (Si) or tin (Sn) or a mixture of oxides thereof and a graphite active material, particulates of silicon or tin, an alloy including silicon or tin as a base material), a compound of metallic lithium and a titanium oxide such as Li₄Ti₅O₁₂, lithium nitride, and/or the like. As the negative electrode active material, one of the described examples may be utilized, or two or more types (or kinds) may be utilized in combination. On the other hand, oxide(s) of silicon may be represented by SiOₓ (0≤x≤2).

The conductive agent is not particularly limited as long as it is for increasing the conductivity of the negative electrode, and for example, the same conductive agent as described in the section of the positive electrode may be utilized.

The negative electrode binder may be, for example, a fluorine-containing resin such as polytetrafluoroethylene (PTFE) and/or polyvinylidene difluoride, an ethylene-containing resin such as a styrene-butadiene rubber, and/or ethylene propylene-diene terpolymer, an acrylonitile-butadiene rubber, a fluororubber, polyvinyl acetate, polymethylmethacrylate, polyethylene, polyvinyl alcohol, carboxymethyl cellulose, a carboxymethylcellulose derivative (a salt of carboxymethylcellulose, and/or the like), nitrocellulose, and/or the like.

The negative electrode binder is not particularly limited as long as it is capable of binding the negative electrode active material and the conductive agent to the negative electrode current collector. From the viewpoint of increasing a weight per unit area of the negative electrode mixture layer, it is desirable that the negative electrode mixture layer includes a fluorine-containing resin such as polytetrafluoroethylene (PTFE) or polyvinylidene fluoride as a binder, and a binder content (e.g., an amount) in the negative electrode mixture layer is greater than or equal to about 0.5 parts by mass and less than or equal to about 10 parts by mass. If the binder content (e.g., an amount) is within this range, a mechanical strength of the negative electrode mixture layer is improved to a level that can ensure good processability, and the energy density of the negative electrode plate can be increased. For example, the electrode mixture layer may include greater than or equal to about 0.5 mass % and less than or equal to about 10 mass % of polytetrafluoroethylene.

### 1-3. Separator

The separator is not particularly limited, and any separator may be utilized as long as it is utilized as a separator for a rechargeable lithium ion battery. The separator may be a porous film, nonwoven fabric, and/or the like that exhibits excellent high-rate discharge performance alone or in combination. The resin comprising (e.g., constituting) the separator may be, for example, a polyolefin-based resin such as polyethylene, polypropylene, and/or the like, a polyester resin such as polyethylene terephthalate, polybutylene terephthalate, and/or the like, polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-hexafluoroethylene copolymer, a vinylidene difluoride-ethylene-tetrafluoroethylene copolymer, and/or the like. On the other hand, a porosity of the separator is not particularly limited, and it is possible to arbitrarily apply a porosity of the separator of a conventional rechargeable lithium ion battery.

On the surface of the separator, there may be a heat resistant layer including inorganic particles. In some embodiments, the inorganic particles may be to improve heat resistance. On the surface of the separator, there may be a layer including an adhesive for fixing the battery element by adhering to the electrode. The inorganic particles may include Al₂O₃, AlOOH, Mg(OH)₂, SiO₂, and/or the like. Examples of the adhesive may include a vinylidene fluoride-hexafluoropropylene copolymer, an acid-modified product of vinylidene fluoride polymers, and/or a styrene-(meth)acrylic acid ester copolymer.

### 1-4. Non-Aqueous Electrolyte

As the non-aqueous electrolyte, a non-aqueous electrolyte that has been utilized for rechargeable lithium ion batteries in the related art may be utilized without particular limitation. The non-aqueous electrolyte may have a composition in which an electrolyte salt may be included in a non-aqueous solvent, which is a solvent for the electrolyte. Examples of the non-aqueous solvent may include cyclic carbonate esters such as propylene carbonate, ethylene carbonate, butylene carbonate, chloroethylene carbonate, fluoroethylene carbonate, and/or vinylene carbonate, cyclic esters such as γ-butyrolactone and/or γ-valerolactone, chain carbonates such as dimethyl carbonate, diethyl carbonate, and/or ethylmethyl carbonate, chain esters such as methylformate, methylacetate, methylbutyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, methyldiglyme, ethylene glycol monopropyl ether, and/or propylene glycol monopropyl ether, nitriles such as acetonitrile and/or benzonitrile, dioxolane or a derivative thereof, ethylene sulfide, sulfolane, sultone, or a derivative thereof, which may be utilized alone or in a mixture of two or more. On the other hand, if (e.g., when) two or more types (or kinds) of non-aqueous solvents are mixed and utilized, a mixing ratio of each non-aqueous solvent may be a mixing ratio that may be utilized in a conventional rechargeable lithium ion battery.

Examples of the electrolyte salt may include an inorganic ion salt including at least one of lithium (Li), sodium (Na) or potassium (K) such as LiClO₄, LiBF₄, LiAsF₆, LiPF₆, LiPF₆₋ₓ(CₙF₂ₙ₊₁)ₓ [provided that 1<x<6 and n=1 or 2], LiSCN, LiBr, LiI, Li₂SO₄, Li₂B₁₀Cl₁₀, NaClO₄, NaI, NaSCN, NaBr, KClO₄, KSCN, NaI, NaSCN, NaBr, KClO₄, KSCN, or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearyl sulfonate, lithium octyl sulfonate), lithium dodecylbenzene sulfonate, and/or the like. In some embodiments, it is also possible to use these ionic compounds alone or in a mixture of two or more types (or kinds). In some embodiments, a concentration of the electrolyte salt may be the same as that of a non-aqueous electrolyte utilized in a comparable rechargeable lithium ion battery, and is not particularly limited. In some embodiments, it is desirable to use a non-aqueous electrolyte including the herein-described lithium compound (electrolyte salt) at a concentration of greater than or equal to about 0.8 mol/L and less than or equal to about 1.5 mol/L.

In some embodiments, various additives may be added to the non-aqueous electrolyte. Examples of such additives may include negative electrode-acting additives, positive electrode-acting additives, ester additives, carbonate ester additives, sulfuric acid ester additives, phosphoric acid ester additives, boric acid ester additives, acid anhydride additives, and/or electrolyte additives. Any one of these may be added to the non-aqueous electrolyte, and multiple types (or kinds) of additives may be added to the non-aqueous electrolyte.

### 2. Characteristic Configuration of Non-Aqueous Electrolyte Rechargeable Battery According to the Present Embodiment

Hereinafter, the characteristic configuration of the non-aqueous electrolyte rechargeable battery according to some embodiments will be described.

### 2-1. Base Layer

The aforementioned negative electrode further includes a base layer. The base layer may be a conductive base layer and the terms “base layer” and “conductive base layer” are utilized in the present disclosure interchangeably. The base layer may be provided between the negative electrode current collector and the negative electrode mixture layer, and may prevent the negative electrode mixture layer from falling off or peeling off (e.g., away from the negative electrode current collector).

The base layer may include a carbon material, a binder (binder for base layer), and/or a dispersant.

The carbon material is not particularly limited as long as it is utilized to increase the conductivity of the base layer. Examples of the carbon material may include those containing one or more types (or kinds) selected from among carbon black, natural graphite, artificial graphite, fibrous carbon, and nanocarbon materials. Examples of the carbon black may include at least one selected from among furnace black, channel black, thermal black, ketjen black, and acetylene black.

Examples of the fibrous carbon include carbon fiber and/or the like.

Examples of the nanocarbon material may include carbon nanotubes, carbon nanofibers, single-layer graphene, and/or multi-layer graphene.

Among carbon materials, it may be desirable to use carbon black, which is easy to disperse. Among carbon blacks, it may be desirable to use acetylene black, which has high conductivity.

A content (e.g., an amount) of the carbon material in the base layer may be greater than or equal to about 5 mass % and less than or equal to about 29 mass %, and for example greater than or equal to about 6 mass % and less than or equal to about 27 mass %. If (e.g., when) the content (e.g., an amount) of the carbon material is greater than or equal to about 5 mass %, the conductivity of the base layer may be improved. In some embodiments, if (e.g., when) the content (e.g., an amount) of the carbon material may be greater than or equal to about 6 mass %, the conductivity of the base layer may be further improved. On the other hand, lowering the content (e.g., an amount) of the carbon material leaves room for increasing the content (e.g., an amount) of the binder and dispersant for the aforementioned base layer, which may provide improved adhesiveness and improved dispersibility of the base layer. Accordingly, the content (e.g., an amount) of the carbon material may be less than or equal to about 29 mass %, less than or equal to about 27 mass %, and for example less than or equal to about 25 mass %.

The binder for the base layer binds each component, such as a carbon material included in the base layer, to each other and also binds the base layer and the negative electrode current collector or the negative electrode mixture layer. For example, the binder for the base layer according to this embodiment may be a styrene-acrylic acid ester-based copolymer.

The term “styrene-acrylic acid ester-based copolymer” refers to a copolymer in which the structural units of the copolymer are mainly formed by polymerizing styrene and acrylic acid ester. For example, the styrene-acrylic acid ester-based copolymer may be a copolymer containing structural units of styrene and acrylic acid ester in a range of greater than or equal to about 80 mass % and less than or equal to about 99 mass %. The acrylic acid ester may include methyl acrylate, ethyl acrylate, butyl acrylate, isopropyl acrylate, octyl acrylate, 2-ethylhexyl acrylate, isobutyl acrylate, pentyl acrylate, n-hexyl acrylate, isoamyl acrylate, lauryl acrylate, stearyl acrylate, isobornyl acrylate, 2-hydroxyethyl acrylate, 2-hydroxypropyl acrylate, 2-hydroxybutyl acrylate, 2-hydroxy-3-phenoxypropyl acrylate, 2-acryloyloxyethyl-2-hydroxyethyl-phthalic acid, ethoxy-diethylene glycol acrylate, methoxy-triethylene glycol acrylate, tetrahydrofurfuryl acrylate, phenoxy-polyethylene glycol acrylate, phenoxydiethylene glycol acrylate, phenoxyethyl acrylate, methoxylethyl acrylate, glycidyl acrylate, acrylonitrile, 2-acrylamide-2-methylpropanesulfonic acid, 2-acryloxyethyl acid phosphate, and/or the like. In some embodiments, the styrene-acrylic acid ester-based copolymer may be butyl acrylate and/or 2-ethylhexyl acrylate.

The styrene-acrylic acid ester-based copolymer may include structural units other than styrene and acrylic acid ester in the range of greater than or equal to about 1 mass % and less than or equal to about 20 mass %.

The structural units included in the styrene-acrylic acid ester-based copolymer may include:
structural units obtained by polymerizing aromatic vinyl compounds such as p-methylstyrene, m-methylstyrene, o-methylstyrene, o-t-butylstyrene, m-t-butylstyrene, p-t-butylstyrene, p-chlorostyrene, and o-chlorostyrene;
structural units obtained by polymerizing unsaturated methacrylic acid alkyl ester compounds, such as methyl methacrylate, ethyl methacrylate, butyl methacrylate, isopropyl methacrylate, octyl methacrylate, 2-ethylhexyl methacrylate, isobutyl methacrylate, pentyl methacrylate, n-hexyl methacrylate, isoamyl methacrylate, lauryl methacrylate, stearyl methacrylate, and/or isobornyl methacrylate; (meth)acrylic acid-based compounds such as methacrylic acid, acrylic acid, itaconic acid, fumaric acid, and/or maleic acid;
structural units obtained by polymerizing unsaturated carboxylic acid amide compounds such as (meth)acrylamide, (meth)N-methylacrylamide, (meth)N-dimethylacrylamide, (meth)N-hydroxymethylacrylamide, (meth)N-butoxymethylacrylamide, and/or (meth)isobutoxymethylacrylamide; and/or
structural units obtained by polymerizing 2-hydroxyethyl methacrylate, 2-hydroxypropyl methacrylate, 2-hydroxybutyl methacrylate, 2-hydroxy-3-phenoxypropyl methacrylate, ethoxy-diethylene glycol methacrylate, methoxy-triethylene glycol methacrylate, tetrahydrofurfuryl methacrylate, phenoxy-polyethylene glycol methacrylate, phenoxydiethylene glycol methacrylate, phenoxyethyl methacrylate, methoxylethyl methacrylate, glycidyl methacrylate, methacrylonitrile, and/or 2-methacryloyloxyethyl acid phosphate.

A glass transition temperature of the styrene-acrylic acid ester-based copolymer may be less than or equal to about 20° C. and greater than or equal to about −20° C. If (e.g., when) the glass transition temperature is within this range, suitable or good adhesion can be obtained even if (e.g., when) the temperature of the hot roll press if (e.g., when) adhering the negative electrode mixture layer to the base layer is not set to an excessively high temperature, for example, exceeding about 120° C. The glass transition temperature of the styrene-acrylic acid ester-based copolymer may be greater than or equal to about −15° C. and less than or equal to about 15° C., and for example greater than or equal to about −10° C. and less than or equal to about 15° C.

The glass transition temperature of the styrene-acrylic acid ester-based copolymer may be adjusted depending on the type (or kind) and content (e.g., an amount) of the copolymer's structural units. Because the styrene-acrylic acid ester-based copolymer includes greater than or equal to about 80 mass % and less than or equal to about 99 mass % of structural units obtained by polymerizing styrene and acrylic acid ester, it may be adjusted by the content (e.g., an amount) of styrene and acrylic acid ester. For example, because the glass transition temperature of styrene homopolymer may be about 100° C., and the glass transition temperature of 2-ethylhexyl acrylate homopolymer may be about −55° C., by adjusting the contents (e.g., an amounts) of styrene and 2-ethylhexyl acrylate, a copolymer having a glass transition temperature between about −55° C. and about 100° C. may be synthesized. In addition, if the glass transition temperature of the homopolymer of the monomers utilized is already known, the calculated glass transition temperature may be obtained utilizing Fox's equation from the volume fraction of these monomer compounds, and by synthesizing a copolymer referring to this and performing differential scanning calorimetry (DSC), a styrene-acrylic acid ester-based copolymer with a glass transition temperature of greater than or equal to about −20° C. and less than or equal to about 20° C. can be obtained.

In order to sufficiently prevent the negative electrode mixture layer from falling off or peeling off (e.g., away) after being immersed in the electrolyte solution by the base layer, a content (e.g., an amount) of the binder for the base layer in the base layer may be greater than or equal to about 70 mass %. In addition, in order to sufficiently ensure the conductivity of the base layer, the content (e.g., an amount) of the binder for the base layer in the base layer may be less than or equal to about 90 mass %. The content (e.g., an amount) of the binder for base layer in the base layer may be greater than about 77.5 mass % and less than or equal to about 90 mass %, greater than or equal to about 78 mass % and less than or equal to about 88 mass %, greater than or equal to about 78 mass % and less than or equal to about 85 mass %, greater than or equal to about 80 mass % and less than or equal to about 85 mass % and for example greater than or equal to about 78 mass % and less than or equal to about 83 mass %.

The dispersant may be utilized to uniformly disperse the carbon material and the binder for the base layer, and in this embodiment, poly(meth)acrylic acid corresponds to this.

The poly(meth)acrylic acid has a plurality of carboxyl groups (e.g., in the molecular structure of the molecule). For example, the carboxyl groups may be neutralized by alkali metal ions such as sodium ions.

In the poly(meth)acrylic acid utilized in this embodiment, it may be desirable that the carboxyl groups are un-neutralized (e.g., are as un-neutralized as possible). In some embodiments, a proportion of neutralized carboxyl groups may be less than or equal to about 25%, based on a total amount of carboxyl groups in the poly(meth)acrylic acid. For example, a proportion of neutralized carboxyl groups (neutralized carboxyl groups) among the carboxyl groups included in poly(meth)acrylic acid may be less than or equal to about 20%, less than or equal to about 10%, and/or for example 0%, or greater than about 0% and less than or equal to about 10%. If (e.g., when) the proportion of neutralized carboxyl groups is 0% the carboxyl groups may be un-neutralized.

A content (e.g., an amount) of the dispersant in the base layer may be greater than or equal to about 1 mass % and less than or equal to about 25 mass %, and for example greater than or equal to about 2 mass % and less than or equal to about 20 mass %. If the content (e.g., an amount) of the dispersant is greater than or equal to about 1 mass %, the herein-described carbon material and the binder for the base layer can be uniformly dispersed, and if (e.g., when) the content (e.g., an amount) of the dispersant is greater than or equal to about 2 mass %, they can be dispersed more uniformly. On the other hand, lowering the content (e.g., an amount) of the dispersant leaves room for increasing the content (e.g., an amount) of the aforementioned binder for the base layer and conductive agent, which may provide (e.g., lead to) improved battery performance by developing good or suitable adhesion of the base layer and lowering the resistance. Accordingly, the content (e.g., an amount) of the dispersant may be less than or equal to about 25 mass %, less than or equal to about 20 mass %, and for example less than or equal to about 15 mass %.

### 3. Manufacturing Method of Non-Aqueous Electrolyte Rechargeable Battery According to Some Embodiments

Hereinafter, the manufacturing method of the non-aqueous electrolyte rechargeable battery according to the present embodiment is described.

### 3-1. Manufacturing Method of Positive Electrode

The positive electrode may be produced as follows.

The positive electrode mixture layer may be manufactured by, for example, mixing a positive electrode active material, a conductive agent, and a positive electrode binder in a desired ratio, kneading the mixture to produce a positive electrode mixture, pressing the positive electrode mixture to produce a positive electrode mixture sheet, and laminating the positive electrode mixture sheet on a positive electrode current collector by heat pressing or the like.

Additionally, a positive electrode mixture layer may be formed by mixing the materials constituting the positive electrode mixture layer and dispersing them in a solvent for positive electrode slurry to produce a positive electrode slurry, coating this positive electrode slurry on a positive electrode current collector, and drying it. In this case, the formed positive electrode mixture layer may be pressed to a desired density utilizing a press machine.

### 3-2. Manufacturing Method of Negative Electrode

The negative electrode may be produced as follows.

First, each component included in the aforementioned base layer may be suspended in a solvent such as water to prepare a base layer slurry in a slurry state, and this base layer slurry may be coated and dried on a negative electrode current collector to form a base layer. In some embodiments, a coating amount of the base layer slurry may be such that the thickness of the base layer after drying may be, for example, greater than or equal to about 0.5 μm and less than or equal to about 5 μm. The thickness of the base layer after drying may be greater than or equal to about 0.5 μm and less than or equal to about 2 μm, and for example, greater than or equal to about 0.5 m and less than or equal to about 1.5 μm. In some embodiments, the method of coating may not be particularly limited. The coating method may include a knife coater method, a gravure coater method, a reverse roll coater, a slit die coater, and/or the like. Each of the following coating processes may be also performed by the same method.

Next, the negative electrode active material, the conductive agent, and the negative electrode binder are mixed in a desired ratio, kneaded to produce a negative electrode mixture and this negative electrode mixture may be pressed to produce a negative electrode mixture sheet. The negative electrode may be produced by a dry method in which this negative electrode mixture sheet may be laminated on the base layer utilizing a hot roll press or the like. In some embodiments, the manufacturing equipment utilized in the process of laminating the negative electrode mixture sheet to the base layer by a dry method may not be particularly limited. As manufacturing equipment utilized in the process of laminating the negative electrode mixture sheet to the base layer, roll press equipment, hot roll press equipment, dry laminator, calendar processing equipment, heat press equipment, and/or the like may be considered. In the described laminating process, for example, if (e.g., when) utilizing a hot roll press equipment, the press roll temperature of the hot roll press equipment can be appropriately changed depending on the material utilized in the negative electrode mixture layer, and/or the like, but may be greater than or equal to about 20° C. and less than or equal to about 150° C., greater than or equal to about 40° C. and less than or equal to about 120° C., and for example greater than or equal to about 60° C. and less than or equal to about 100° C. Moreover, the rotation speed of the press roll may be greater than or equal to about 0.1 meter (m) per minute and less than or equal to about 10 m per minute, greater than or equal to about 0.1 m per minute and less than or equal to about 5 m per minute, and for example greater than or equal to about 0.1 m per minute and less than or equal to about 1.0 m per minute. Suitable parameters, including the temperature of the press roll and the rotational speed of the press roll, may have different desirable ranges depending on the hot roll press equipment utilized, and the parameters may be adjusted depending on each hot roll press equipment. If (e.g., when) laminating the negative electrode mixture sheets, the weight per unit area of the negative electrode mixture layer on one surface of the negative electrode current collector may be adjusted to be greater than or equal to about 10 milligram per square centimeter (mg/cm²) and less than or equal to about 35 mg/cm².

Additionally, a negative electrode slurry may be prepared by dispersing a mixture of the materials constituting the negative electrode mixture layer in a solvent for the negative electrode slurry. Next, a negative electrode mixture layer may be formed by coating the negative electrode slurry onto the negative electrode current collector and drying it. If (e.g., when) forming the negative electrode mixture layer by coating and drying in this way, the negative electrode mixture layer may be pressed utilizing a press machine to obtain the desired density described herein.

### 3-3. Manufacturing Method of Non-Aqueous Electrolyte Rechargeable Battery

Next, an electrode structure may be manufactured by placing a separator between the positive electrode and the negative electrode. Then, the electrode structure may be processed into a desired or suitable shape (e.g., cylindrical shape, prismatic shape, laminated shape, button shape, and/or the like) and inserted into a container of the described shape. Subsequently, a non-aqueous electrolyte may be inserted into the corresponding container to impregnate the electrolyte into each pore in the separator or a gap between the positive electrode and negative electrode. Accordingly, a rechargeable lithium ion battery may be manufactured.

### 4. Effect by the Present Embodiment

According to the non-aqueous electrolyte rechargeable battery configured as herein, high energy density of the non-aqueous electrolyte rechargeable battery may be achieved by increasing the weight per unit area of the negative electrode mixture layer and reducing the thickness of the base layer as much as possible and falling off and/or peeling off (e.g., away) of the negative electrode mixture layer from the current collector after immersion in the electrolyte solution may be sufficiently suppressed.

### 5. Another Embodiment

The present disclosure is not limited to the aforementioned embodiments. In the herein-described embodiment, the case where the base layer may be formed only on one surface of the negative electrode current collector has been described, but the base layer and the negative electrode mixture layer may be provided on both (e.g., opposite) surfaces of the negative electrode current collector.

In the described embodiment, the case where the base layer may be provided between the negative electrode current collector and the negative electrode mixture layer has been described. However, the base layer according to the present disclosure may be installed between the positive electrode current collector and the positive electrode mixture layer, and can prevent the positive electrode mixture layer from falling off or peeling off (e.g., away).

The base layer according to the present disclosure is not limited to non-aqueous electrolyte rechargeable batteries that do not have a solid electrolyte layer, but may also be applied to semi-solid rechargeable batteries or all-solid rechargeable batteries that have a solid electrolyte layer.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

In addition, the present disclosure is not limited to these embodiments but may be variously modified without deviating from the purpose.

### EXAMPLES

Hereinafter, the present disclosure will be described in more detail according to specific examples. However, the following examples are only one or more example embodiments of the present disclosure, and the present disclosure is or should not limited to the following examples.

### Preparation of Base Layer Slurry

Acetylene black as a carbon material, polyacrylic acid as a dispersant, and an aqueous dispersion of an acrylic acid ester-based copolymer (having a glass transition temperature: 15° C., measured by DSC (X-DSC7000, Hitachi High Tech Science Corporation)) as a binder for a base layer were respectively utilized to form a base layer slurry with a composition shown in Table 1 and/or 2.

As a procedure, the carbon material and the dispersant were first mixed for 20 minutes by utilizing a disperser, and then, this mixed solution was subjected to a high pressure dispersion treatment by utilizing a NanoVator manufactured by Yoshida Industrial Machinery Co., Ltd. The high pressure dispersion treatment was three times repeated to obtain an acetylene black dispersion. On the other hand, if (e.g., when) this acetylene black dispersion was dried into a solid at 120° C. and weighed, a dried solid content (e.g., an amount) (a solid concentration) of the acetylene black dispersion was about 8 mass %.

Subsequently, this acetylene black dispersion with the described aqueous dispersion of the binder at a solid concentration of 40% was added to a stirring container, which was mounted on a rotating/revolving mixer ARE-310 manufactured by Thinky Inc., and then, mixed for 10 minutes to obtain the base layer slurry. On the other hand, if (e.g., when) the base layer slurry was dried into a solid and weighed, a dried solid content (e.g., an amount) (solid concentration) of the base layer slurry was about 15 mass %.

A content (e.g., an amount) ratio of each component in the base layer slurry was almost the same as parts by mass of each component based on 100 parts by mass of a base layer formed by removing the solvent from the base layer slurry.

### Coating of Base Layer Slurry

After respectively preparing an about 8 micrometer (μm)-thick copper foil as a negative electrode current collector and an about 12 μm-thick aluminum foil as a positive electrode current collector, the base layer slurry obtained according to the aforementioned method was coated on one surface of each current collector. In each example and comparative example, the base layer slurry applied onto a negative electrode current collector had various compositions as shown in Tables 1 to 4. On the other hand, the base layer slurry applied on the positive electrode current collector was not only common in all the examples and comparative examples but also the same as that applied to a negative electrode current collector in Comparative Example 1. The base layer slurry was coated to have a thickness of 1 μm thick by utilizing a micro gravure applicator and then, dried at 80° C. for 1 minute to form a 1 μm-thick base layer on the current collector. On the other hand, in Comparative Example 2 of Table 2, the base layer slurry was immediately hardened, failing in coating the base layer slurry on a negative electrode current collector from the beginning.

### Evaluation of Slurry Viscosity Stability of Base Layer Slurry

The viscosity of the base layer slurry was evaluated with a B-type viscometer (DV-E viscometer, Brookfield).

The viscosities immediately after the preparation of base layer slurry of Examples 1 to 9 and Comparative Examples 1 and 2 were 100 to 200 mPa·s. In the evaluation of slurry viscosity stability, if the viscosity was less than 5000 mPa·s one day after the preparation of base layer slurry, ∘ was given and if it was 5000 mPa·s or more, x was given. The results are shown in Tables 1 to 4.

### Manufacturing of Negative Electrode

### Manufacturing of Negative Electrode Mixture Sheet 1

Powders of natural graphite, artificial graphite, single-layer carbon nanotube, and polytetrafluoroethylene were weighed in a mass ratio of 48.2:48.2:0.1:3.5 and kneaded in a mortar for 10 minutes. After the kneading, a lump-shaped negative electrode mixture was about 100 times passed between two rolls to manufacture a negative electrode mixture sheet with a thickness of about 180 μm and density of 1.2 gram per cubic centimeter (g/cm³) to 1.4 g/cm³. In the process of about 100 times passing the lump-shaped negative electrode mixture between the two rolls, a gap of the two rolls was gradually narrowed from 3 mm to finally to about 0.1 mm.

In order to adjust density of the negative electrode mixture sheet obtained in the aforementioned method to 1.6 g/cm³ and a weight per unit area of the negative electrode mixture layer to 17 milligram per cubic centimeter mg/cm², the negative electrode mixture sheet was roll-pressed by a hot roll press. The hot roll press was set at a temperature of 75° C. and a rotation speed of 0.5 m/min. After adjusting the roll gap into 30 μm, the negative electrode mixture sheet formed with a dimension of 3.0 cm×8.0 cm was 3 to 8 times passed in a length direction. In the rolling process, a total pressure was 3 kilonewton (kN), and a linear pressure was 100 kilonewton per meter (kN/m). The manufactured negative electrode mixture sheet was punched to 15.5 q (e.g., a diameter of 15.5 mm) and measured with respect to a weight and a thickness. The obtained weight and thickness were utilized to calculate negative electrode active mass density and weight per unit area of the negative electrode mixture layer, which were respectively about 1.6 g/cm³ and about 17 mg/cm².

### Manufacturing of Negative Electrode Mixture Sheet 2

In the rolling process, the weight per unit area of the negative electrode mixture layer was reduced by increasing the number of times of rolling the negative electrode mixture sheet passing between rolls. In the rolling process, the number of times of rolling the negative electrode mixture sheet passing between the rolls was changed from 25 to 35 to manufacture a Negative electrode mixture sheet 2 having a negative electrode active mass density of about 1.6 g/cm³ and a weight per unit area of the negative electrode mixture layer of about 10 mg/cm².

### Manufacturing of Negative Electrode Mixture Sheet 3

A plurality of the negative electrode mixture sheets manufactured in the rolling process was overlapped and rolled to increase the weight per unit area of the negative electrode mixture layer. Two negative electrode mixture sheets having negative electrode active mass density of about 1.6 g/cm³ and a weight per unit area of the negative electrode mixture layer of about 17.5 mg/cm² were overlapped in a plane direction and then, rolled by changing the roll gap to 60 μm to manufacture Negative electrode mixture sheet 3 having negative electrode active mass density of about 1.6 g/cm³ and a weight per unit area of the negative electrode mixture layer of about 35 mg/cm².

### Adhesion of Negative Electrode Mixture Sheet 1 to Current Collector

Negative electrode mixture sheet 1 manufactured in the described method was adhered by a hot roll press onto a current collector on which a base layer was formed to manufacture each negative electrode according to Examples 1 to 9 and Comparative Example 1 shown in Table 1.

First, a temperature of the hot roll press was set at 80° C., and a rotation speed of the rolls was set at 0.5 m/min. After adjusting the roll gap to 45 μm, each negative electrode mixture sheet was mounted on the base layer coated to be 1 μm thick on the current collector and then, once passed between the rolls. On the other hand, the rotation speed of the rolls utilized in each example and comparative example could have an error of about ±0.2 meter (m) per minute but had no effect on properties of the manufactured negative electrode mixture sheets. In addition, the roll gaps utilized in each example and comparative example could have an error of about ±10 μm but had no particular problem. In the adhesion process, a total pressure was 3 kN, and a linear pressure was 100 KN/m. The negative electrodes manufactured in this way were dried at 145° C. for 6 hours in a vacuum-drier. After the vacuum-drying, the negative electrodes were punched to 15.5 q and measured with respect to a weight and a film thickness. The weight and the film thickness were utilized to calculate negative electrode active mass density and a weight per unit area of the negative electrode mixture layer, which were respectively about 1.6 g/cm³ and about 17.0 mg/cm².

### Adhesion of Negative Electrode Mixture Sheets 2 and 3 to Current Collector

Negative electrode mixture sheets 2 and 3 were adhered in the same adhesion process as Negative electrode mixture sheet 1 except that the roll gap was changed. The roll gap was adjusted to be a value obtained by the following calculation formula according to a weight per unit area of the utilized negative electrode mixture sheet.

(Roll gap)=(Weight per unit area of the negative electrode mixture sheet utilized)+17×45 μm

### Performance Evaluation Test of Negative Electrode

Method for Evaluating the Adhesion of the Negative Electrode Mixture Layer to the Negative Electrode Current Collector after Immersion in Electrolyte Solution

As described herein, each of the manufactured negative electrodes was put with an electrolyte solution into an aluminum laminate and then, sealed with a laminator and stored at 60° C. for 3 days in a thermostat. The electrolyte solution was prepared by mixing ethylene carbonate/dimethyl carbonate/ethylmethyl carbonate in a volume ratio of 20/20/40 and dissolving 1.15 M LiPF₆ and 1.0 mass % of vinylene carbonate in the mixed solvent. The utilized electrolyte solution had a volume of 2.0 milliliter (mL). After 3 days, the aluminum laminate was taken out of the thermostat and moved to a dry room with a dew point of −30° C. The aluminum laminate was opened to take out a negative electrode plate, and then, the electrolyte solution was wipe off quickly enough therefrom. The negative electrode plate was cut into a rectangle with a width of 25 mm and a length of 80 mm. Subsequently, the surface of the negative electrode on which the mixture layer was formed was bonded to a stainless plate by utilizing a double-sided adhesive tape to prepare a sample for evaluating close contacting property (adhesion). The sample for evaluating close contacting property was mounted on a peeling tester (SHIMAZU EZ-S manufactured by Shimazu Corp.) and measured with respect to peel strength with a length of 60 mm at 180° by setting a peeling seed of 100 mm/min.

Evaluation Criteria for the Adhesion of the Negative Electrode Mixture Layer to the Negative Electrode Current Collector after Immersion in Electrolyte Solution

If (e.g., when) the peel strength was 2.0 gram force per millimeter (gf/mm) or more, “⊚” was given. If (e.g., when) the peel strength was 0.5 gf/mm or more and less than 2.0 gf/mm, “∘” was given. If (e.g., when) the peel strength was less than 0.5 gf/mm, “x” was given. The results are shown in Table 1.

### Manufacturing of Positive Electrode

### Manufacturing of Positive Electrode Mixture Sheet 1

Powders of LiNi_{0.8}Co_{0.1}Al_{0.1}O₂, acetylene black, and polytetrafluoroethylene were weighed in a mass ratio of 93.0:3.5:3.5 and kneaded in a mortar for 10 minutes. After the kneading, a lump-shaped positive electrode mixture was about 100 times passed between two rolls to manufacture a positive electrode mixture sheet with a film thickness of about 150 μm and density of 2.9 g/cm³ to 3.1 g/cm³.

In the process of about 100 times passing the lump-shaped positive electrode mixture between the two rolls, a gap between the two rolls was gradually narrowed from 3 mm finally to about 0.1 mm.

In order to adjust the positive electrode active mass density of a positive electrode mixture sheet obtained in the described method and a weight per unit area of the positive electrode mixture layer respectively to 3.6 g/cm³ and 30.0 mg/cm², the positive electrode mixture sheet was rolled by utilizing a hot roll press. A temperature of the hot roll press was set at 40° C., and a rotation speed of the rolls was set at 0.5 m/min. After adjusting the roll gap to 10 μm, the positive electrode mixture sheet formed with a dimension of 3.0 cm×8.0 cm was twice passed between the rolls in a length direction. Subsequently, the roll gap was adjusted to 5 μm to twice pass the positive electrode mixture sheet. In the rolling process, a total pressure was 3 kN, and a linear pressure was 100 KN/m. If (e.g., when) the manufactured positive electrode mixture sheet was punched to 15.5 @ measure a weight and a film thickness, the film thickness was about 100 μm, positive electrode active mass density was about 3.6 g/cm³, and a weight per unit area was about 30.0 mg/cm².

### Manufacturing of Positive Electrode Mixture Sheet 2

In the rolling process, the weight per unit area of the positive electrode mixture layer was reduced by increasing the number of rolling the positive electrode mixture sheet passing between the rolls. In the rolling process, the number of times of rolling the positive electrode mixture sheet passing between the rolls was changed from 25 to 35 to manufacture Positive electrode mixture sheet 2 having positive electrode active mass density of about 3.6 g/cm³ and a weight per unit area of the mixture layer of about 18 mg/cm².

### Manufacturing of Positive Electrode Mixture Sheet 3

A plurality of the positive electrode mixture sheets manufactured in the rolling process was overlapped and rolled to increase the weight per unit area of the positive electrode mixture layer. Two positive electrode mixture sheets having positive electrode active mass density of about 3.6 g/cm³ and a weight per unit area of the positive electrode mixture layer of about 31 mg/cm² were overlapped in a plane direction and then, rolled by changing the roll gap to 60 μm to manufacture Positive electrode mixture sheet 3 having positive electrode active mass density of about 3.6 g/cm³ and a weight per unit area of the positive electrode mixture layer of about 62 mg/cm².

### Adhesion of Positive Electrode Mixture Sheet 1 to Current Collector

Positive electrode mixture sheet 1 prepared in the described method was adhered by utilizing a hot roll press onto a positive electrode current collector on which a base layer was formed to manufacture a positive electrode. As described in the section of the Coating of Base Layer Slurry, the base layer slurry applied on the positive electrode current collector was not only common in all the examples and comparative examples but also the same as that applied to a negative electrode current collector in Comparative Example 1.

First, a temperature of the hot roll press was set at 60° C., and a rotation speed of the rolls was set at 0.5 m/min. After adjusting the roll gap to 60 μm, each positive electrode mixture sheet was mounted on the base layer coated to be 1 μm thick on the current collector and then, once passed between the rolls. On the other hand, the rotation speed of the rolls utilized in each example and comparative example could have an error of about ±0.2 m per minute but had no effect on properties of the manufactured positive electrode mixture sheets. In addition, the roll gaps utilized in each example and comparative example could have an error of about ±10 μm but had no particular problem. In the adhesion process, a total pressure was 3 kN, and a linear pressure was 100 KN/m. The positive electrodes manufactured in this way was dried at 80° C. for 6 hours in a vacuum-drier. After the vacuum-drying, the positive electrodes were punched to 15.5 q and measured with respect to a weight and a film thickness. The weight and the film thickness were utilized to calculate positive electrode active mass density and a weight per unit area of the positive electrode mixture layer, which were respectively about 3.6 g/cm³ and about 30.0 mg/cm².

### Adhesion of Positive Electrode Mixture Sheets 2 and 3 to Current Collector

Positive electrode mixture sheets 2 and 3 were adhered in the same adhesion process as Positive electrode mixture sheet 1 except that the roll gap was changed. The roll gap was adjusted to be a value obtained by the following calculation formula according to a weight per unit area of the utilized positive electrode mixture sheet.

(Roll gap)=(Weight per unit area of the positive electrode mixture sheet utilized)+30×60 μm

### Preparation of Rechargeable Battery Cell

After respectively welding a nickel wire and an aluminum wire to each negative electrode according to Examples 1 to 9 and Comparative Example 1 and the positive electrode, a polyethylene porous separator was provided to stack one sheet of the negative electrode and one sheet of the positive electrode to face each other into an electrode stack structure. Subsequently, the electrode stack was housed in an aluminum laminate film with the lead wires externally pulled out, an electrolyte was injected thereinto, and the aluminum laminate film was sealed under a reduced pressure to manufacture a rechargeable battery cell before initial charge. The electrolyte was prepared by dissolving 1.15 M LiPF₆ and 1 mass % of vinylene carbonate in a mixed solvent of ethylene carbonate/dimethyl carbonate/fluoroethylene carbonate in a volume ratio of 20/20/40. On the other hand, in order to optimally balance weights per unit area of the positive electrode and the negative electrode in each example and comparative example, Negative electrode mixture sheet 2 and Positive electrode mixture sheet 2 in Examples 1 to 9 and Comparative Examples 1 and 2, Negative electrode mixture sheet 1 and Positive electrode mixture sheet 1 in Examples 3-10, Negative electrode mixture sheet 3 and Positive electrode mixture sheet 3 in Examples 3-11 were respectively utilized to manufacture rechargeable battery cells.

### Aging of Rechargeable Battery Cell

The rechargeable battery cells manufactured by utilizing each negative electrode according to Examples 1 to 9 and Comparative Example 1 and the positive electrode in the above method were stored at 45° C. for 12 hours in the thermostat before charging and discharging and continuously stored at 25° C. for 24 hours.

### Formation Charging and Discharging of Rechargeable Battery Cell

The rechargeable battery cells manufactured by utilizing each negative electrode according to Examples 1 to 9 and Comparative Example 1 and the positive electrode aged in the above method were connected to a charge and discharge device and then, subjected to formation charge and discharge at 25° C. in the thermostat. The initial charge and discharge were performed by utilizing a charge and discharge program of constant current-charging at 0.1 CA, constant voltage-charging at 0.05 CA, and constant current-discharging at 0.1 CA with a charge cut-off voltage of 4.25 V and a discharge cut-off voltage of 2.8 V. The 2nd and 3rd charges and discharges were respectively performed by utilizing a charge and discharge program of constant current-charging at 0.2 CA, constant voltage-charging at 0.05 CA, and constant current-discharging at 0.2 CA with a charge cut-off voltage of 4.25 V and a discharge cut-off voltage of 2.8 V.

### Rate Characteristic Test of Rechargeable Battery Cell

The rechargeable battery cells after the above formation charge and discharge was constant current-charged at 0.33 CA and constant voltage-charged at 0.05 CA with a charge cut-off voltage of 4.25 V and then, constant current discharged at 2 CA with a discharge cut-off voltage of 2.8 V. If (e.g., when) full-charge capacity of the cells, which were charged at 0.33 CA, was determined to be SOC 100%, a discharge voltage where discharge capacity of the cells, which were constant current-discharged at 2 CA, reached SOC 10% was checked. If (e.g., when) the discharge voltage checked in the above method was greater than or equal to 3.85 V, “⊚” was given, if (e.g., when) the discharge voltage was greater than or equal to 3.75 V and less than 3.85 V, “∘” was given, if (e.g., when) the discharge voltage was greater than or equal to 3.5 V and less than 3.75 V, “Δ” was given, and if (e.g., when) the discharge voltage was less than 3.5 V, “x” was given. The results are shown in Table 1.

TABLE 1

| | | | | | | Adhesion | | |
|---|---|---|---|---|---|---|---|---|
| | | | | | Base | after | | |
| | Base layer composition | | | Dispersant | layer | immersion | | |
| | (dried product, part by mass) | | | neutralization | film | in | 2 CA | Slurry |
| | | Carbon | | degree | thickness | electrolyte | discharge | viscosity |
| | Binder | material | Dispersant | (mol %) | (μm) | solution | voltage | stability |
| Ex. 1 | 70 | 21 | 9 | 0 | 1 | ∘ | ⊚ | ∘ |
| Ex. 2 | 78 | 15.4 | 6.6 | 0 | 1 | ⊚ | ⊚ | ∘ |
| Ex. 3 | 80 | 14 | 6 | 0 | 1 | ⊚ | ⊚ | ∘ |
| Ex. 4 | 80 | 14 | 6 | 10 | 1 | ⊚ | ⊚ | ∘ |
| Ex. 5 | 80 | 14 | 6 | 25 | 1 | ⊚ | ∘ | ∘ |
| Ex. 6 | 82.5 | 12.25 | 5.25 | 0 | 1 | ⊚ | ∘ | ∘ |
| Ex. 7 | 85 | 10.5 | 4.5 | 0 | 1 | ⊚ | ∘ | ∘ |
| Ex. 8 | 87.5 | 8.75 | 3.75 | 0 | 1 | ⊚ | ∘ | ∘ |
| Ex. 9 | 90 | 7 | 3 | 0 | 1 | ⊚ | ∘ | ∘ |
| Comp. | 60 | 28 | 12 | 0 | 1 | x | ⊚ | ∘ |
| Ex. 1 | | | | | | | | |

### Consideration of Evaluation Results

Referring to the results of Table 1, Examples 1 to 9 having a base layer with a binder content (e.g., an amount) of 70 mass % or more exhibited a sufficiently large weight per unit area of a negative electrode mixture layer of 17 mg/cm², and even if the base layer had a sufficiently thin thickness of 1 μm thick, compared with Comparative Example 1, the negative electrodes with improved close contacting properties after dipping in the electrolyte solution were provided.

For example, the negative electrodes of Examples 1 to 9 exhibited a large enough close contacting force before dipping in the electrolyte solution of 3 gf/mm or more. Furthermore, if (e.g., when) the base layer was set to have a binder content (e.g., an amount) of 90 mass % or less, close contacting property of the negative electrode mixture layer to the current collector was not only sufficiently increased but also rate characteristics of the cells were maintained within an appropriate or suitable range.

Peeling off (e.g., away) and falling off of the negative electrode mixture layer after dipping in the electrolyte solution could cause a decrease in electrical capacity of the rechargeable battery cells, a decrease in the rate performance, and a decrease in cycle-life characteristics. In this regard, the base layer utilized in Examples 1 to 9 of the present disclosure, as described herein, had sufficiently large close contacting property after dipping in the electrolyte solution and thus may be advantageous in terms of improving electrical capacity, rate performance, and cycle-life characteristics of rechargeable battery cells.

TABLE 2

| | Base layer composition | | | Dispersant | |
|---|---|---|---|---|---|
| | (dried product, part by mass) | | | neutralization | Slurry |
| | | Carbon | | degree | viscosity |
| | Binder | material | Dispersant | (mol %) | stability |
| Ex. 3 | 80 | 14 | 6 | 0 | ∘ |
| Ex. 4 | 80 | 14 | 6 | 10 | ∘ |
| Ex. 5 | 80 | 14 | 6 | 25 | ∘ |
| Comp. Ex. 2 | 80 | 14 | 6 | 50 | x |

As shown in Table 2, in Examples 3 to 5, compared with Comparative Example 2, a dispersant exhibited a neutralization degree of 25% or less, which confirmed that the dispersant was sufficiently adsorbed to a carbon material to generate a sufficiently large repulsive force between particles of the carbon material, resultantly sufficiently dispersing the carbon material in the base layer slurry.

In addition, if (e.g., when) a base layer with the same composition as in Example 3 was formed to have a film thickness of greater than or equal to 0.5 μm and less than or equal to 5 μm, the evaluation results are shown in Table 3.

TABLE 3

| | | | | | | Adhesion | | |
|---|---|---|---|---|---|---|---|---|
| | | | | | Base | after | | |
| | Base layer composition | | | Dispersant | layer | immersion | | |
| | (dried product, part by mass) | | | neutralization | film | in | 2 CA | Slurry |
| | | Carbon | | degree | thickness | electrolyte | discharge | viscosity |
| | Binder | material | Dispersant | (mol %) | (μm) | solution | voltage | stability |
| Ex. 3 | 80 | 14 | 6 | 0 | 1 | ⊚ | ⊚ | ∘ |
| Ex. 3-2 | 80 | 14 | 6 | 0 | 0.5 | ⊚ | ⊚ | ∘ |
| Ex. 3-3 | 80 | 14 | 6 | 0 | 1.5 | ⊚ | ⊚ | ∘ |
| Ex. 3-4 | 80 | 14 | 6 | 0 | 2 | ⊚ | ⊚ | ∘ |
| Ex. 3-5 | 80 | 14 | 6 | 0 | 5 | ⊚ | ⊚ | ∘ |

Referring to Table 3, even with a very thin film thickness of greater than or equal to 0.5 μm, less than or equal to 5 μm and sufficiently large close contacting property after dipping in the electrolyte solution was obtained. In addition, even if (e.g., when) the thickness was changed to 5 μm, there was no effect on a discharge voltage of the battery cells.

If (e.g., when) the base layer with the same composition as in Example 3 was utilized, but a weight per unit area of the negative electrode mixture layer was changed, the evaluation results are shown in Table 4.

TABLE 4

| | | | | | | Weight | Adhesion | | |
|---|---|---|---|---|---|---|---|---|---|
| | | | | | Base | per unit | after | | |
| | Base layer composition | | | Dispersant | layer | area of | immersion | | |
| | (dried product, part by mass) | | | neutralization | film | mixture | in | 2 CA | Slurry |
| | | Carbon | | degree | thickness | layer | electrolyte | discharge | viscosity |
| | Binder | material | Dispersant | (mol %) | (μm) | (mg/cm²) | solution | voltage | stability |
| Ex. 3 | 80 | 14 | 6 | 0 | 1 | 17 | ⊚ | ⊚ | ∘ |
| Ex. 3-10 | 80 | 14 | 6 | 0 | 1 | 10 | ⊚ | ⊚ | ∘ |
| Ex. 3-11 | 80 | 14 | 6 | 0 | 1 | 35 | ⊚ | ⊚ | ∘ |

Referring to Table 4, even if (e.g., when) the weight per unit area of the negative electrode mixture layer was greater than or equal to 10 mg/cm² and less than or equal to 35 mg/cm², sufficient close contacting property after dipping in the electrolyte solution was obtained.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims, and equivalents thereof.

What is claimed is:

1. An electrode, the electrode comprising
a current collector;
an electrode mixture layer; and
a base layer between the current collector and the electrode mixture layer,
wherein
the base layer comprises at least one selected from among a styrene-acrylic acid ester-based copolymer, a carbon material, and a poly(meth)acrylic acid,
an amount of the styrene-acrylic acid ester-based copolymer in the base layer is greater than or equal to about 70 mass % and less than or equal to about 90 mass %, and
the poly(meth)acrylic acid comprises a plurality of carboxyl groups, the plurality of carboxyl groups being not neutralized by alkali metal ions or a proportion of neutralized carboxyl groups neutralized by alkali metal ions among the carboxyl groups is less than or equal to about 25%,
a weight per unit area of the electrode mixture layer per a surface of the current collector is greater than or equal to about 10 milligram per square centimeter (mg/cm²) and less than or equal to about 35 mg/cm², and
the negative electrode is for a non-aqueous electrolyte rechargeable battery.

2. The electrode as claimed in claim 1, wherein an amount of the styrene-acrylic acid ester-based copolymer in the base layer is greater than about 77.5 mass % and less than or equal to about 90 mass %.

3. The electrode as claimed in claim 1, wherein
an amount of the styrene-acrylic acid ester-based copolymer in the base layer is greater than or equal to about 78 mass % and less than or equal to about 85 mass %.

4. The electrode as claimed in claim 1, wherein
an amount of the styrene-acrylic acid ester-based copolymer in the base layer is greater than or equal to about 80 mass % and less than or equal to about 85 mass %.

5. The electrode as claimed in claim 1, wherein
the base layer has a thickness of greater than or equal to about 0.5 micrometer (μm) and less than or equal to about 5 μm.

6. The electrode as claimed in claim 5, wherein
the base layer has a thickness of greater than or equal to about 0.5 μm and less than or equal to about 2 μm.

7. The electrode as claimed in claim 1, wherein
the styrene-acrylic acid ester-based copolymer has a glass transition temperature of greater than or equal to about −20° C. and less than or equal to about 20° C.

8. The electrode as claimed in claim 1, wherein
the electrode mixture layer includes greater than or equal to about 0.5 mass % and less than or equal to about 10 mass % of polytetrafluoroethylene.

9. The electrode as claimed in claim 1, wherein
the plurality of carboxyl groups are not neutralized or the proportion of neutralized carboxyl groups is greater than about 0% and less than or equal to about 10%.

10. The electrode as claimed in claim 1, wherein
the carbon material comprises at least one selected from among furnace black, channel black, thermal black, ketjen black, and acetylene black.

11. A non-aqueous electrolyte rechargeable battery, the non-aqueous electrolyte rechargeable battery comprising:
a positive electrode,
a negative electrode,
a separator between the positive electrode and the negative electrode, and
an electrolyte,
wherein at least one of the positive electrode and the negative electrode is the electrode as claimed in claim 1.
